(19) United States
(12) Patent Application Publication
(10) Pub. No.: US 2026/0077479 A1
(43) Pub. Date: Mar. 19, 2026

(54) YIELD CHECKING FOR A HAND-HELD MANIPULATION DEVICE

(71) Applicant: Toyota Research Institute, Inc., Los Altos, CA (US)

(72) Inventors: Blake Wulfe, San Francisco, CA (US); Yuki Noguchi, Los Altos, CA (US); Mikhal Itkina, Los Altos, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/080,170

(22) Filed: Mar. 14, 2025

Related U.S. Application Data
(60) Provisional application No. 63/694,483, filed on Sep. 13, 2024.

(51) Int. Cl. B25J 9/00; B25J 9/16; G06T 7/73; G11B 27/10

(52) U.S. Cl. CPC B25J 9/0081; B25J 9/1697; G06T 7/73; G06T 2207/10016; G06T 2207/20081; G11B 27/10

(57) ABSTRACT

A method includes receiving a mapping video of a scene; generating a map of the scene based on the mapping video; receiving a plurality of demonstration videos of a hand-held manipulation device performing one or more tasks in the scene; for each video among the plurality of demonstration videos, determining whether the hand-held manipulation device can be localized in the scene based on the video and the map; and for each video among the plurality of demonstration videos for which the hand-held manipulation device can be localized in the scene, localizing the hand-held manipulation device in the scene based on the video and the map, and storing the video as training data.

### CROSS-REFERENCE TO RELATED APPLICATION

The present specification is based on, and claims the benefit of U.S. Provisional Application No. 63/694,483, filed September 13, 2024, the disclosure of which is hereby incorporated by reference in its entirety.

### TECHNICAL FIELD

The present specification relates to robotic object manipulation, and more particularly to yield checking for a hand-held manipulation device.

### BACKGROUND

One way to train robots to perform physical manipulation tasks is to record video or images of humans performing a task, and then train a robot to perform the same task through imitation learning. In particular, a human may utilize a hand-held gripper to perform a task while a camera records video of the human performing the task with the hand-held gripper. A large number of trials of humans performing the task using the hand-held gripper may be recorded with the camera. This collection of trials may then be used as training data to train a robotic arm, having similar grippers as the hand-held gripper, to perform the task by mimicking the behavior of the hand-held gripper controlled by humans in the training data.

In order to use such videos as training data, a mapping video may first be recorded, and a map of a scene in which tasks are to be performed may be generated. Subsequent videos of hand-held devices performing tasks may then be analyzed, and the hand-held devices may be localized within the scene based on the generated map. However, in some instances, it may not be possible to localize every video of tasks being performed. Accordingly, a need exists for yield checking for a hand-held manipulation device.

### SUMMARY

In one embodiment, a method includes receiving a mapping video of a scene; generating a map of the scene based on the mapping video; receiving a plurality of demonstration videos of a hand-held manipulation device performing one or more tasks in the scene; for each video among the plurality of demonstration videos, determining whether the hand-held manipulation device can be localized in the scene based on the video and the map; and for each video among the plurality of demonstration videos for which the hand-held manipulation device can be localized in the scene, localizing the hand-held manipulation device in the scene based on the video and the map, and storing the video as training data.

In another embodiment, a computing device includes one or more processors configured to receive a mapping video of a scene; generate a map of the scene based on the mapping video; receive a plurality of demonstration videos of a hand-held manipulation device performing one or more tasks in the scene; for each video among the plurality of demonstration videos, determine whether the hand-held manipulation device can be localized in the scene based on the video and the map; and for each video among the plurality of demonstration videos for which the hand-held manipulation device can be localized in the scene, localize the hand-held manipulation device in the scene based on the video and the map, and store the video as training data.

In another embodiment, a non-transitory computer readable storage medium includes a memory storing a program. When executed by a processor, the program may cause the processor to receive a mapping video of a scene; generate a map of the scene based on the mapping video; receive a plurality of demonstration videos of a hand-held manipulation device performing one or more tasks in the scene; for each video among the plurality of demonstration videos, determine whether the hand-held manipulation device can be localized in the scene based on the video and the map; and for each video among the plurality of demonstration videos for which the hand-held manipulation device can be localized in the scene, localize the hand-held manipulation device in the scene based on the video and the map, and store the video as training data.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1A depicts a hand-held manipulation device, according to one or more embodiments shown and described herein;

FIG. 1B depicts another view of the hand-held manipulation device of FIG. 1A, according to one or more embodiments shown and described herein;

FIG. 2 depicts an example robot, according to one or more embodiments shown and described herein;

FIG. 3 depicts an example computing device, according to one or more embodiments shown and describe herein;

FIG. 4 depicts example memory modules of the computing device of FIG. 3, according to one or more embodiments shown and described herein;

FIG. 5 depicts a user utilizing two hand-held manipulation devices of FIGS. 1A and 1B to perform a task, according to one or more embodiments shown and described herein; and

FIG. 6 depicts a flowchart of a method of operating the computing device of FIG. 3.

### DETAILED DESCRIPTION

The embodiments disclosed herein include yield checking for a hand-held manipulation device. In embodiments, a hand-held manipulation device may include grippers with a variety of sensors therein. The hand-held manipulation device may also include a camera that can capture images and/or video of the grippers. As such, when a user holds the hand-held manipulation device and performs a physical manipulation task with the grippers, the camera may capture video of the grippers performing the task.

In embodiments, before performing tasks with such a hand-held manipulation device, a user may record a mapping video of a scene in which tasks are to be performed. This mapping video may be used to generate a map of the scene. The user may then perform a series of tasks using the hand-held manipulation device. As each task is performed, the camera associated with the device may capture video of the task being performed. A computing device may analyze the video of each task and attempt to localize the hand-held device in the scene. If the hand-held device can be localized, then the video may be stored as training data, which may be used to train a robot to perform the task via imitation learning. However, if the hand-held device cannot be localized, then the video may be discarded. The computing device may determine a yield, indicating a percentage of such videos for which the hand-held device can be localized. The computing device may also determine a reason why the hand-held device was unable to be localized for each such video, and may output this determination to a user such that the yield may be increased.

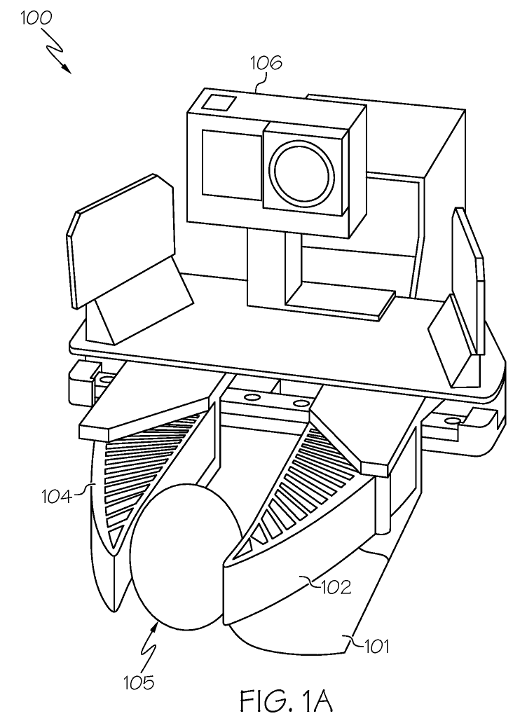

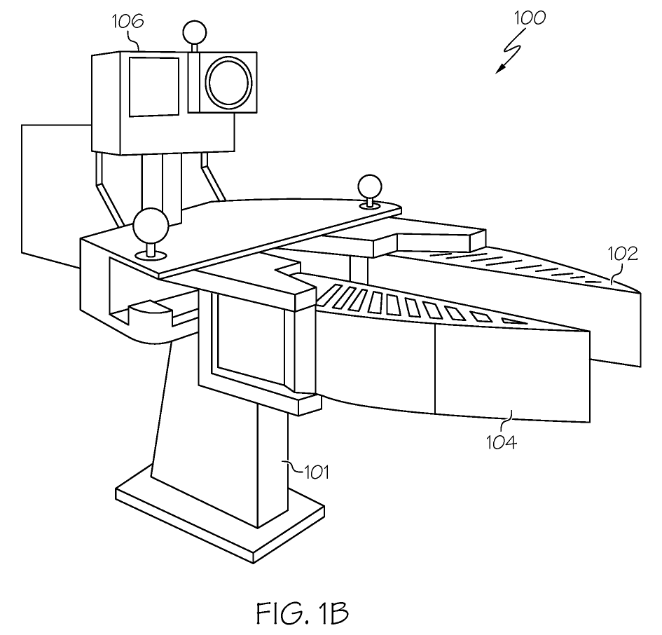

Turning now to the figures, FIGS. 1A and 1B depict an example hand-held manipulation device 100 from two different perspectives. The device 100 may include a handle 101 that may be gripped by a user. The device 100 includes grippers 102 and 104, which may be used to grip objects. In particular, the grippers 102, 104 may have a finger-like shape to pick up and manipulate objects. The handle 101 may include a trigger or other mechanism to close the grippers 102, 104. This may allow a user to grasp and manipulate objects with the grippers 102, 104. In the example of FIG. 1A, the grippers 102, 104 are holding an egg 105.

In the illustrated example, the grippers 102 and 104 may be made of a compliant material, such as an elastomer. This may allow for manipulation of objects by the grippers 102, 104 without damaging the objects. In some examples, the grippers 102, 104 may contain one or more sensors (e.g., tactile sensors, vibration sensors, acoustic sensors, and the like). These sensors may gather sensor data about objects being manipulated by the grippers 102, 104.

The hand-held manipulation device 100 may also include a computing device 106 including a camera. The computing device 106 may be affixed to the device 100 such that the grippers 102, 104 are within the field of view of a lens of a camera. Accordingly, the camera of the computing device 106 may capture images and/or video of the grippers 102, 104 while the user performs tasks with the device 100. As such, the computing device 106 may collect training data that may be used to train a robot to perform the tasks. The computing device 106 is described in further detail below. In some examples, the device 100 may comprise a camera that is separate from the computing device 106,

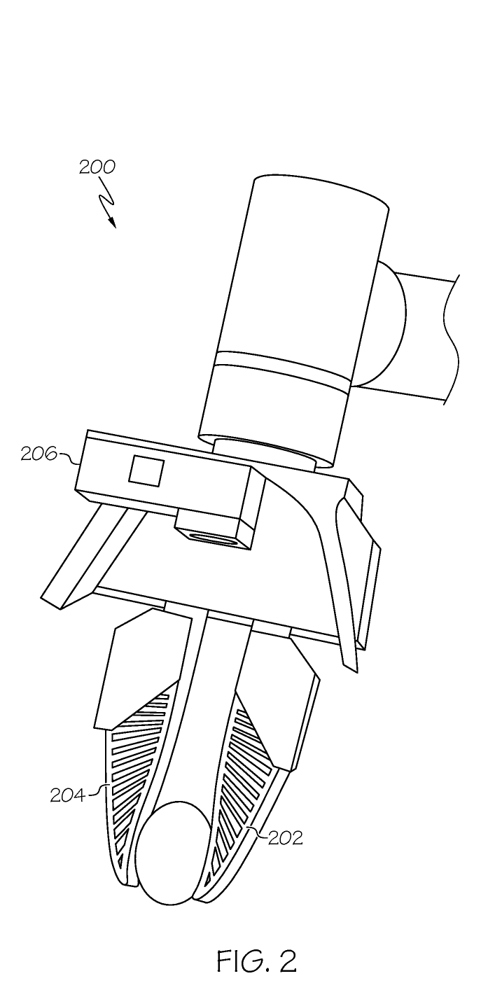

FIG. 2 depicts an example robot 200 that may be trained to perform tasks based on training data collected by the device 100. In the example of FIG. 2, the robot 200 comprises grippers 202, 204 similar to the grippers 102, 104 of FIGS. 1A and 1B. The robot 200 may also comprise a computing device 206 having a camera similar to the computing device 106 of FIGS. 1A and 1B. In operation, the robot 200 may be trained to perform tasks based on training data collected by the device 100. In particular, the robot 200 may be trained to perform tasks using imitation learning. After the robot 200 is trained, the robot 200 may perform specified tasks according to the training using the grippers 202, 204 and the camera of the computing device 206. In particular, the camera of the computing device 206 may capture images of a scene and various motors of the robot 200 may control operation of the grippers 202 204 to perform a specified task.

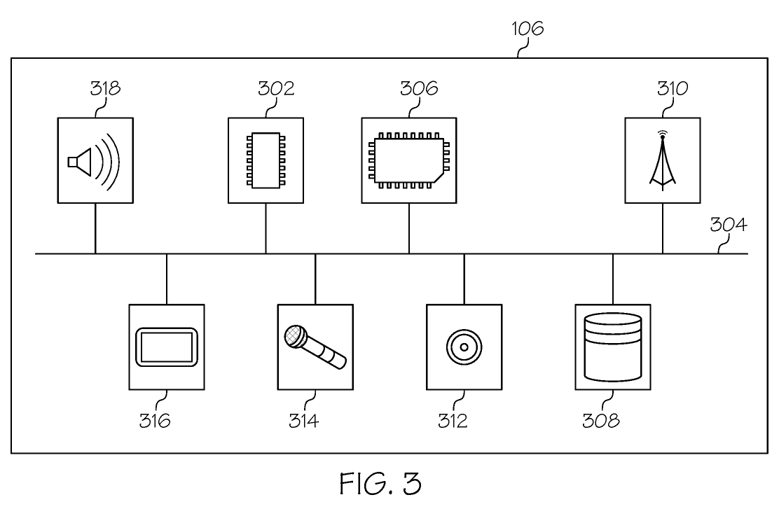

FIG. 3 schematically depicts the computing device 106 of FIGS. 1A and 1B. The computing device 106 may perform the operations of the embodiments disclosed herein. In the illustrated example, the computing device 106 includes one or more processors 302, a communication path 304, one or more memory modules 306, a data storage component 308, network interface hardware 310, a camera 312, a microphone 314, a screen 316, and a speaker 318, the details of which will be set forth in the following paragraphs.

Each of the one or more processors 302 may be any device capable of executing machine readable and executable instructions. Accordingly, each of the one or more processors 302 may be a controller, an integrated circuit, a microchip, a computer, or any other physical or cloud-based computing device. The one or more processors 302 are coupled to a communication path 304 that provides signal interconnectivity between various modules of the computing device 106. Accordingly, the communication path 304 may communicatively couple any number of processors 302 with one another, and allow the modules coupled to the communication path 304 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 304 may be formed from any medium that is capable of transmitting a signal such as, for example, conductive wires, conductive traces, optical waveguides, or the like. In some embodiments, the communication path 304 may facilitate the transmission of wireless signals, such as WiFi, Bluetooth^{®}, Near Field Communication (NFC), and the like. Moreover, the communication path 304 may be formed from a combination of mediums capable of transmitting signals. In one embodiment, the communication path 304 comprises a combination of conductive traces, conductive wires, connectors, and buses that cooperate to permit the transmission of electrical data signals to components such as processors, memories, sensors, input devices, output devices, and communication devices. Additionally, it is noted that the term "signal" means a waveform (e.g., electrical, optical, magnetic, mechanical or electromagnetic), such as DC, AC, sinusoidal-wave, triangular-wave, square-wave, vibration, and the like, capable of traveling through a medium.

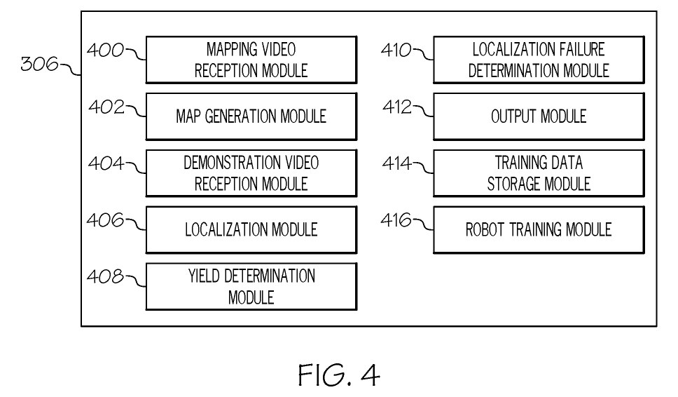

The computing device 106 includes one or more memory modules 306 coupled to the communication path 304. The one or more memory modules 306 may comprise RAM, ROM, flash memories, hard drives, or any device capable of storing machine readable and executable instructions such that the machine readable and executable instructions can be accessed by the one or more processors 302. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 306. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 306 are discussed in more detail below in connection with FIG. 4.

Referring still to FIG. 3, the example computing device 106 includes a data storage component 308. The data storage component 308 may store data used by the computing device 106. The data storage component 308 may also store other data used by the various components of the computing device 106. The data storage component 308 may also store image data captured by the computing device 106, as disclosed in further detail below.

Still referring to FIG. 3, the computing device 106 comprises network interface hardware 310 for communicatively coupling the computing device 106 to the external computing devices. As such, the network interface hardware 310 may send data to and/or receive data from various external computing devices. The network interface hardware 310 may comprise a wired and/or wireless connection to one or more external computing devices. In other examples, the network interface hardware 310 may be send data to and/or receive data from other computing devices.

The network interface hardware 310 can be communicatively coupled to the communication path 304 and can be any device capable of transmitting and/or receiving data via a network. Accordingly, the network interface hardware 310 can include a communication transceiver for sending and/or receiving any wired or wireless communication. For example, the network interface hardware 310 may include an antenna, a modem, LAN port, Wi-Fi card, WiMax card, mobile communications hardware, near-field communication hardware, satellite communication hardware and/or any wired or wireless hardware for communicating with external computing devices.

Referring still to FIG. 3, the computing device 106 comprises a camera 312. As discussed above, the camera 312 may capture images and/or video of tasks performed by the grippers 102, 104 of the device 100. In particular, the field of view of the camera 312 may include the grippers 102, 104 such that movements and operations of the grippers 102, 104 may be captured by the camera 312. While the example of FIG. 3 shows the computing device 106 including the camera 312, in some examples, the camera 312 may be a separate device from the computing device 106. In these examples, the camera 312 may transmit captured images to the computing device 106.

Referring still to FIG. 3, the computing device 106 comprises a microphone 314. The microphone 314 may capture audio, such as words spoken by a user. In particular, before a user utilizes the grippers 102, 104 to perform a task, the user may verbally speak the name of the task that they are about to perform. This statement may be recorded by the microphone 314 and used to appropriately classify the training images associated with the task, as discussed in further detail below.

Referring still to FIG. 3, the computing device 106 comprises a screen 316. The screen 316 may display visual information output by the computing device 106, as disclosed in further detail below. The computing device 106 also comprises a speaker 318. The speaker 318 may output audio information output by the computing device 106, as disclosed in further detail below.

Referring now to FIG. 4, the one or more memory modules 306 of the computing device 106 include a mapping video reception module 400, a map generation module 402, a demonstration video reception module 404, a localization module 406, a yield determination module 408, a localization failure determination module 410, an output module 412, a training data storage module 414, and a robot training module 416. Each of the mapping video reception module 400, the map generation module 402, the demonstration video reception module 404, the localization module 406, the yield determination module 408, the localization failure determination module 410, the output module 412, the training data storage module 414, and the robot training module 416 may be a program module in the form of operating systems, application program modules, and other program modules stored in the one or more memory modules 306. Such a program module may include, but is not limited to, routines, subroutines, programs, objects, components, data structures, and the like for performing specific tasks or executing specific data types as will be described below.

The mapping video reception module 400 may receive a mapping video recorded by the camera 312 of the device 100. In particular, when a user preparing to generate training data by performing tasks with the device 100, the user may first generate a mapping video by moving the device 100 along a pattern while recording video. The pattern may be such that an entire area of a scene is captured by the mapping video. The user may be encouraged to move slowly so as to avoid motion blur while recording the mapping video.

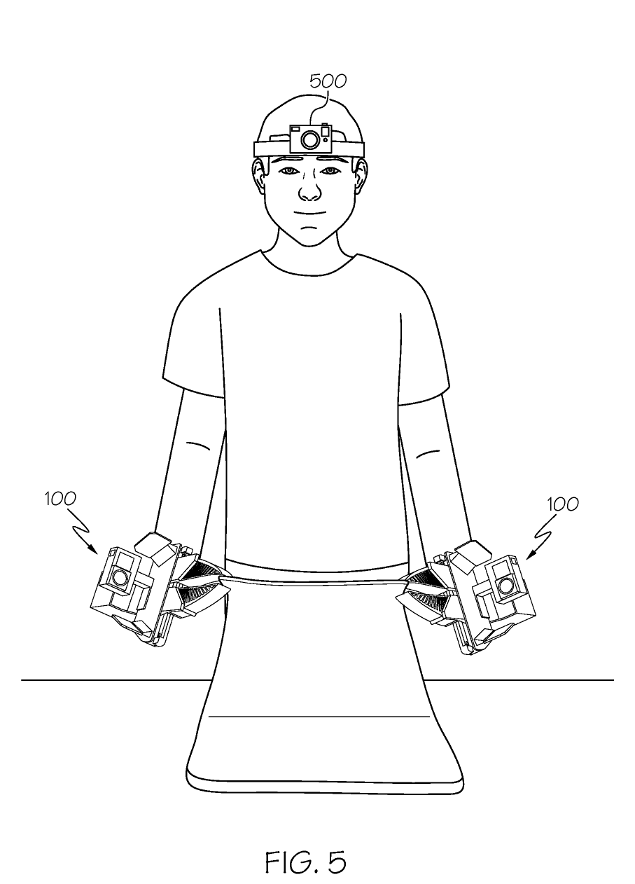

In some examples, the user may utilize two devices 100, with one device held in each hand, and the user may also wear a head-mounted camera 500, as shown in FIG. 5. In these examples, the user may record a mapping video with either one of the devices 100 or with the head-mounted camera 500. In some examples, the user may initialize the start of the mapping video by pressing a button or switch on the computing device 106, or speaking a command into the microphone 314 (e.g., “start mapping”). Such an action may cause the camera 312 associated with one of the devices 100 or the head-mounted camera 500 to begin recording. The user may then move the camera recording the video around the scene such that video of the entire scene is recorded. After video of the entire scene has been recorded, the user may end the recording of the mapping video by pressing a button or switch on the computing device 106, or speaking another command into the microphone 314 (e.g., “stop mapping”). This may cause the camera to stop recording the mapping video. The mapping video may then be received by the mapping video reception module 400.

In some examples, the user may also record a gripper calibration video, as disclosed herein. In particular, the user may slowly close and open the grippers 102, 104 of the device 100 while video is being recorded. The calibration video may be used to localize the device 100, as disclosed in further detail below. However, in some examples, a calibration video may not be recorded or use to perform localization.

Referring back to FIG. 4, the map generation module 402 may generate a map of the scene based on the video received by the mapping video reception module 400, as disclosed herein. The map generation module 402 may use a variety of algorithms to generate the map. In some examples, the map generation module 402 may use a simultaneous localization and mapping (SLAM) algorithm. Once the map of the scene is generated, the map may be utilized to localize the devices 100 as tasks are being performed by the user, as disclosed in further detail below.

Referring still to FIG. 4, the demonstration video reception module 404 may receive demonstration videos of tasks being performed by the user with the device or devices 100, as disclosed herein. As discussed above, after the user records a mapping video and a gripper calibration video, the user may begin performing tasks with the device or devices 100. The camera or cameras 312 associated with the device or devices 100 and/or the head-mounted camera 500 may record videos of the tasks being performed, which may be received by the demonstration video reception module 404. In particular, as each task is performed, a separate video may be recorded by the camera 312 associated with each device 100 used to perform the task and the head-mounted camera 500.

In operation, before a user performs a particular task with the device or devices 100, the user may speak the name of the task that they are about to perform into the microphone 314 (e.g., “folding clothes”). The user may then perform the task. The audio indicating the name of the task to be performed may be stored along with the video of the task being performed as training data, as discussed in further detail below. As such, the audio indicating the task to be performed may be used as a label during training of the robot. In some examples, the user may also speak a command such as “start task” to indicate the start of the task being performed and a command such as “stop task” to indicate the end of the task being performed.

After the performance of each task, the video from the device or devices 100 and the head-mounted camera 500 may be received by the demonstration video reception module 404. In some examples, before performing the tasks, the clocks associated with each camera may be synchronized such that the videos of each task being performed recorded by different cameras may be synchronized when the separate videos are recorded as training data. The demonstration video reception module 404 may receive each of the demonstration videos and store the videos as training data in the data storage component 308 along with the name of the task being demonstrated. Each such video may be used as training data to train a robot via imitation learning, as discussed in further detail below.

Referring still to FIG. 4, the localization module 406 may localize the device or devices 100 in the scene for each demonstration video received by the demonstration video reception module 404 based on the received video and the map determined by the map generation module 402. In particular, the localization module 406 may localize the device or devices 100 by determining the location of the device or devices 100 at each point during the demonstration video. In the illustrated example, the localization module 406 may utilize the SLAM algorithm to localize the device or devices 100. In other examples, the localization module 406 may utilize any other suitable algorithm to localize the device or devices 100.

In some examples, the map generation module 402 may identify one or more features in the scene (e.g., locations of particular objects), and the localization module 406 may perform localization of the device or devices 100 in part based on the identification of those same features in the demonstration videos (e.g., by recognizing the same objects). In some examples, the localization module 406 may utilize the calibration video, discussed above, to assist in performing the localization of the device or devices 100.

In some instances, the localization module 406 may not be able to localize the device or devices 100 in the scene of a demonstration video for a variety of reasons. For example, there may be a change in the environment of the scene between when the mapping video and a demonstration video was recorded, or a demonstration video may have excessively jerky motion that hinders the ability of the localization module 406 to perform localization. As such, the yield determination module 408 may determine a yield, indicating a percentage of the demonstration videos received by the demonstration video reception module 404 for which the device or devices 100 can be localized by the localization module 406. If the localization module 406 is unable to localize the device or devices 100 in a particular demonstration video, the localization failure determination module 410 may determine a reason that the localization module 406 was unable to perform the localization.

Referring still to FIG. 4, the output module 412 may output the yield determined by the yield determination module 408 and/or the reason that localization was unable to be performed for a particular demonstration video. If the yield is particularly low, this may encourage the user to redo certain demonstrations in order to improve the yield. In particular, by outputting the reasons that localization was unable to be performed, the user may be able to avoid the behaviors or problems that led to the failure to perform the localization in subsequent task demonstrations. The yield and/or the reason that localization was unable to be performed may be displayed on the screen 316 and/or output via audio by the speaker 318.

Referring still to FIG. 4, the training data storage module 414 may store the demonstration videos for which localization was able to be performed in the data storage component 308. The training data storage module 414 may store these demonstration videos along with the name of the task being performed in each such demonstration video, as discussed above. This may allow the name of the task being performed to be used as a label associated with the demonstration video during training of the robot via imitation learning. Demonstration videos for which localization was unable to be performed may be discarded.

Referring still to FIG. 4, the robot training module 416 may utilize the training data, comprising the demonstration videos received by the demonstration video reception module 404, to train a robot to perform tasks. In particular, the robot training module 416 may utilize imitation learning to train a robot, such as the robot 200 of FIG. 2, to perform tasks. The name of the tasks stored in association with the video of the tasks being performed may be used as ground truth data.

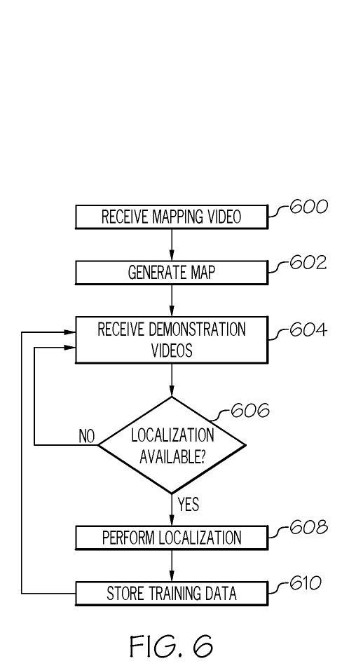

FIG. 6 depicts a flowchart of an example method for operating the computing device 106. At step 600, the mapping video reception module 400 receives a mapping video. As discussed above, the mapping video may be recorded by the camera 312 of the device 100 or by the head-mounted camera 500 as the user moves the camera around the scene.

At step 602, the map generation module 402 generates a map of the scene based on the mapping video received by the mapping video reception module 400. As discussed above, the map generation module 402 may determine the map using the SLAM algorithm.

At step 604, the demonstration video reception module 404 receives a plurality of demonstration videos of the device or devices 100 performing one or more tasks in the scene mapped by the map generation module 402. In an example where tasks are performed with a single device 100, the demonstration video reception module 404 may receive a video from a first device 100 of each task being performed. In an example where tasks are performed with two devices 100, the demonstration video reception module 404 may receive a first video from a first device 100 of each task being performed and a second video from a second device 100 of each task being performed. In an example where the head-mounted camera 500 is used, the demonstration video reception module 404 may receive a first video from a first device 100 of each task being performed, a second video from a second device 100 of each task being performed, and a third video from the head-mounted camera 500 of each task being performed.

In some examples, the demonstration videos received by the demonstration video reception module 404 may be synchronized. In an example where the user performs tasks with two devices 100, a first clock associated with a first device 100 may be synchronized with a second clock associated with a second device 100. In an example where the head-mounted camera 500 is also used, a first clock associated with a first device 100 may be synchronized with a second clock associated with a second device 100 and a third clock associated with a head-mounted camera 100.

At step 604, for each received demonstration video, the localization module 406 determines whether the device or devices 100 can be localized in the scene based on the demonstration video and the map. In one example, as discussed above, the localization module 406 may determine whether the device or devices 100 can be localized in the scene using the SLAM algorithm.

If the localization module 406 determines that localization cannot be performed (NO at step 606), then control returns to step 604, and the demonstration video reception module 404 receives the next demonstration video. If the localization module 406 determines that localization can be performed (YES at step 606), then at step 608, the localization module 406 performs localization of the device or devices 100 in the scene based on the demonstration video and the map. At step 610, the training data storage module 414 may store the demonstration videos for which localization was able to be performed in the data storage component 308 as training data.

It should now be understood that embodiments described herein are directed to yield checking for a hand-held manipulation device. By automatically determining whether hand-held manipulation devices in a demonstration video can be localized and determining a yield and reasons why any such videos could not be localized, a user may take corrective actions in future demonstration videos to increase the yield. This may increase the amount of training data available to train robots to performs tasks via imitation learning.

It is noted that the terms "substantially" and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving a mapping video of a scene;
generating a map of the scene based on the mapping video;
receiving a plurality of demonstration videos of a hand-held manipulation device performing one or more tasks in the scene;
for each video among the plurality of demonstration videos, determining whether the hand-held manipulation device can be localized in the scene based on the video and the map; and
for each video among the plurality of demonstration videos for which the hand-held manipulation device can be localized in the scene, localizing the hand-held manipulation device in the scene based on the video and the map, and storing the video as training data.

2. The method of claim 1, further comprising:
determining a yield indicating a percentage of the plurality of demonstration videos for which the hand-held manipulation device can be localized in the scene; and
outputting the yield.

3. The method of claim 1, further comprising:
for at least one of the videos among the plurality of the demonstration videos for which the hand-held manipulation device cannot be localized in the scene, determining a reason that the hand-held manipulation device cannot be localized in the scene; and
outputting the reason.

4. The method of claim 1, further comprising:
receiving the plurality of demonstration videos of the hand-held manipulation device performing the one or more tasks from a first camera associated with the hand-held manipulation device;
receiving a second plurality of demonstration videos of the hand-held manipulation device performing the one or more tasks from a second camera associated with a second hand-held manipulation device;
synchronizing a first clock associated with the first camera and a second clock associated with the second camera; and
storing the plurality of demonstration videos and the second plurality of demonstration videos as the training data.

5. The method of claim 1, further comprising:
receiving the plurality of demonstration videos of the hand-held manipulation device performing the one or more tasks from a first camera associated with the hand-held manipulation device;
receiving a second plurality of demonstration videos of the hand-held manipulation device performing the one or more tasks from a second camera associated with a second hand-held manipulation device;
receiving a third plurality of demonstration videos of the hand-held manipulation device performing the one or more tasks from a head-mounted camera;
synchronizing a first clock associated with the first camera, a second clock associated with the second camera, and a third clock associated with the head-mounted camera; and
storing the plurality of demonstration videos, the second plurality of demonstration videos, and the third plurality of demonstration videos as the training data.

6. The method of claim 1, further comprising:
localizing the hand-held manipulation device in the scene using a simultaneous localization and mapping algorithm.

7. The method of claim 1, further comprising:
identifying one or more features in the mapping video; and
localizing the hand-held manipulation device in the scene based at least in part on the one or more features.

8. The method of claim 1, further comprising:
receiving a calibration video associated with the hand-held manipulation device; and
localizing the hand-held manipulation device in the scene based at least in part on the calibration video.

9. The method of claim 1, further comprising:
training a robot to perform the one or more tasks based on the training data.

10. A computing device comprising one or more processors configured to:
receive a mapping video of a scene;
generate a map of the scene based on the mapping video;
receive a plurality of demonstration videos of a hand-held manipulation device performing one or more tasks in the scene;
for each video among the plurality of demonstration videos, determine whether the hand-held manipulation device can be localized in the scene based on the video and the map; and
for each video among the plurality of demonstration videos for which the hand-held manipulation device can be localized in the scene, localize the hand-held manipulation device in the scene based on the video and the map, and store the video as training data.

11. The computing device of claim 10, wherein the one or more processors are further configured to:
determine a yield indicating a percentage of the plurality of demonstration videos for which the hand-held manipulation device can be localized in the scene; and
output the yield.

12. The computing device of claim 10, wherein the one or more processors are further configured to:
for at least one of the videos among the plurality of the demonstration videos for which the hand-held manipulation device cannot be localized in the scene, determine a reason that the hand-held manipulation device cannot be localized in the scene; and
output the reason.

13. The computing device of claim 10, wherein the one or more processors are further configured to:
receive the plurality of demonstration videos of the hand-held manipulation device performing the one or more tasks from a first camera associated with the hand-held manipulation device;
receive a second plurality of demonstration videos of the hand-held manipulation device performing the one or more tasks from a second camera associated with a second hand-held manipulation device;
synchronize a first clock associated with the first camera and a second clock associated with the second camera; and
store the plurality of demonstration videos and the second plurality of demonstration videos as the training data.

14. The computing device of claim 10, wherein the one or more processors are further configured to:
receive the plurality of demonstration videos of the hand-held manipulation device performing the one or more tasks from a first camera associated with the hand-held manipulation device;
receive a second plurality of demonstration videos of the hand-held manipulation device performing the one or more tasks from a second camera associated with a second hand-held manipulation device;
receive a third plurality of demonstration videos of the hand-held manipulation device performing the one or more tasks from a head-mounted camera;
synchronize a first clock associated with the first camera, a second clock associated with the second camera, and a third clock associated with the head-mounted camera; and
store the plurality of demonstration videos, the second plurality of demonstration videos, and the third plurality of demonstration videos as the training data.

15. The computing device of claim 10, wherein the one or more processors are further configured to:
localize the hand-held manipulation device in the scene using a simultaneous localization and mapping algorithm.

16. The computing device of claim 10, wherein the one or more processors are further configured to:
identify one or more features in the mapping video; and
localize the hand-held manipulation device in the scene based at least in part on the one or more features.

17. The computing device of claim 10, wherein the one or more processors are further configured to:
receive a calibration video associated with the hand-held manipulation device; and
localize the hand-held manipulation device in the scene based at least in part on the calibration video.

18. The computing device of claim 10, wherein the one or more processors are further configured to:
train a robot to perform the one or more tasks based on the training data.

19. A non-transitory computer readable storage medium comprising a memory storing a program that, when executed by a processor, causes the processor to:
receive a mapping video of a scene;
generate a map of the scene based on the mapping video;
receive a plurality of demonstration videos of a hand-held manipulation device performing one or more tasks in the scene;
for each video among the plurality of demonstration videos, determine whether the hand-held manipulation device can be localized in the scene based on the video and the map; and
for each video among the plurality of demonstration videos for which the hand-held manipulation device can be localized in the scene, localize the hand-held manipulation device in the scene based on the video and the map, and store the video as training data.

20. The non-transitory computer readable storage medium of claim 19, wherein the program further causes the processor to:
determine a yield indicating a percentage of the plurality of demonstration videos for which the hand-held manipulation device can be localized in the scene; and
output the yield.
